(19) United States
(12) Patent Application Publication
(10) Pub. No.: US 2012/0307042 A1
(43) Pub. Date: Dec. 6, 2012

(54) SYSTEM AND METHOD FOR CONTROLLING UNMANNED AERIAL VEHICLE

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/435,067

(22) Filed: Mar. 30, 2012

(30) Foreign Application Priority Data
Jun. 2, 2011 (TW) 100119468

(51) Int. Cl. H04N 7/18

(52) U.S. Cl. 348/114; 348/E07.085

(57) ABSTRACT

An unmanned aerial vehicle (UAV) includes a driving unit and a control unit. The control unit detects a human figure in an image of a scene of a monitored area, determines coordinate differences between the scene image's center and the figure image's center, and determines a tilt direction and a tilt angle of a lens of the image capture unit based on the coordinate differences. If the tilt angle falls within an allowable rotation range of the lens, the control unit controls the driving unit to directly rotate the lens by the tilt angle along the tilt direction. Otherwise, the control unit controls the driving unit to rotate the lens by a threshold angle along the tilt direction, and further controls the driving unit to adjust a flight orientation and a flight height of the UAV until the figure image's center superposes the scene image's center.

### BACKGROUND

1. Technical Field

The embodiments of the present disclosure relate to aircraft control systems and methods, and more particularly to a system and method for controlling an unmanned aerial vehicle (UAV) in flight.

2. Description of Related Art

An unmanned aerial vehicle (UAV), also known as an unmanned aircraft system (UAS) or a remotely piloted aircraft (RPA), is a vehicle which is guided and/or functions under control of a remote navigator. The UAV is often preferred for monitoring desolate or dangerous areas. However, at present, many UAV cannot automatically recognize and track people appearing in the areas being monitored.

### BRIEF DESCRIPTION OF THE DRAWINGS

FIG. 1 is a block diagram of one embodiment of an unmanned aerial vehicle (UAV) including a UAV control unit.

FIG. 2A and FIG. 2B are flowcharts of one embodiment of a UAV controlling method.

FIG. 3 and FIG. 4 are images of a scene captured by an image capture unit within the UAV.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

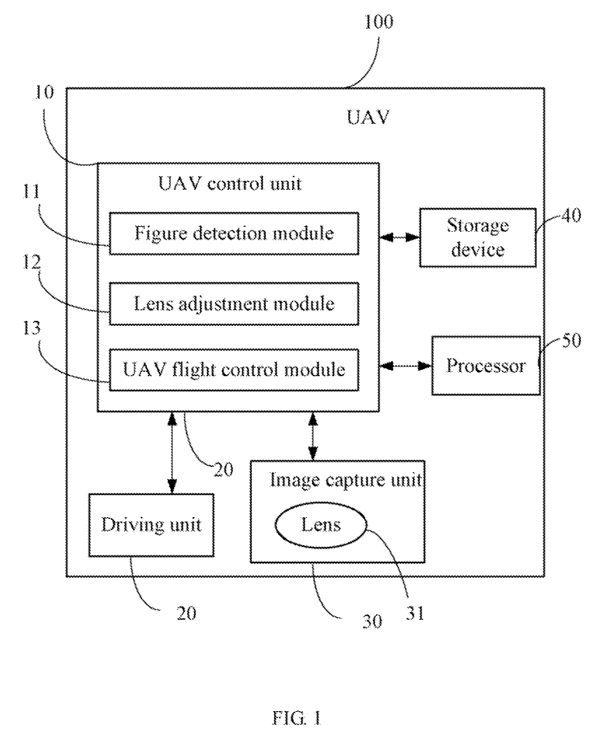

FIG. 1 is a block diagram of one embodiment of an unmanned aerial vehicle (UAV) 100. In this one embodiment, the UAV 100 includes a UAV control unit 10, a driving unit 20, an image capture unit 30, a storage device 40, and a processor 50. The image capture unit 30 is a video camera having night viewing capabilities and pan/tilt/zoom functions, and is used to capture one or more images of one or more scenes (hereinafter, “scene image”) of a monitored area. As shown in FIG. 1, the image capture unit 30 includes a lens 31. The UAV control unit 10 analyzes the scene image to detect an image of a person (hereinafter, “figure image”) from the scene image, determines location information of the figure image within the scene image, and a ratio of an area of the figure image to a total area of the scene image, and generates control commands to adjust a tilt angle and a focus of the lens 31, and a flight height and a flight orientation of the UAV 100 based on the location information and the ratio information of the figure image within the scene image.

The driving unit 20, which includes one or more motors, receives the control commands sent by the UAV control unit 10, and adjusts the tilt angle and the focus of the lens 31, and the flight height and the flight orientation of the UAV 100 according to the control commands.

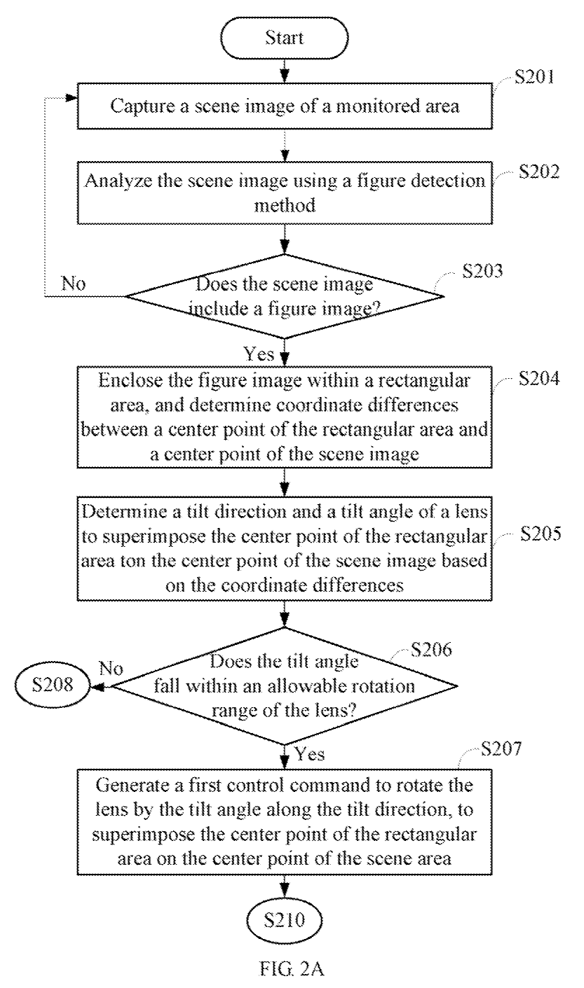

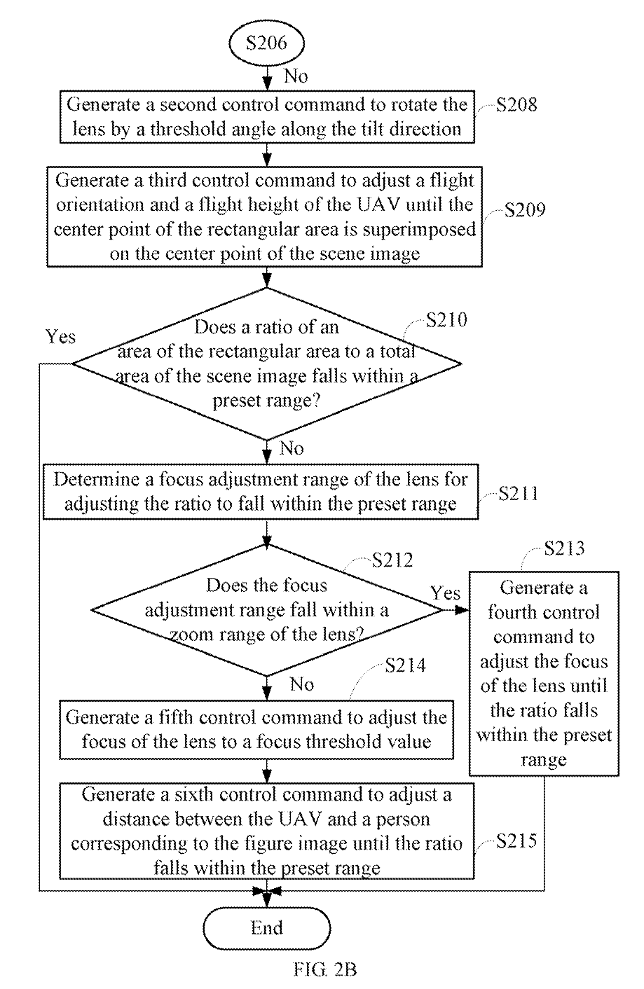

In one embodiment, the UAV control unit 10 includes a figure detection module 11, a lens adjustment module 12, and a UAV flight control module 13. The modules 11-13 may comprise computerized code in the form of one or more programs that are stored in the storage device 40. The computerized code includes instructions that are executed by the processor 50, to provide the aforementioned functions of the UAV control unit 10. A detailed description of the functions of the modules 11-13 is given in FIG. 2A and FIG. 2B. The storage device 40 may be a cache or a dedicated memory, such as an erasable programmable read only memory (EPROM), a hard disk driver (HDD), or flash memory.

FIG. 2A and FIG. 2B show a flowchart of one embodiment of a UAV controlling method. Depending on the embodiment, additional steps may be added, others removed, and the ordering of the steps may be changed.

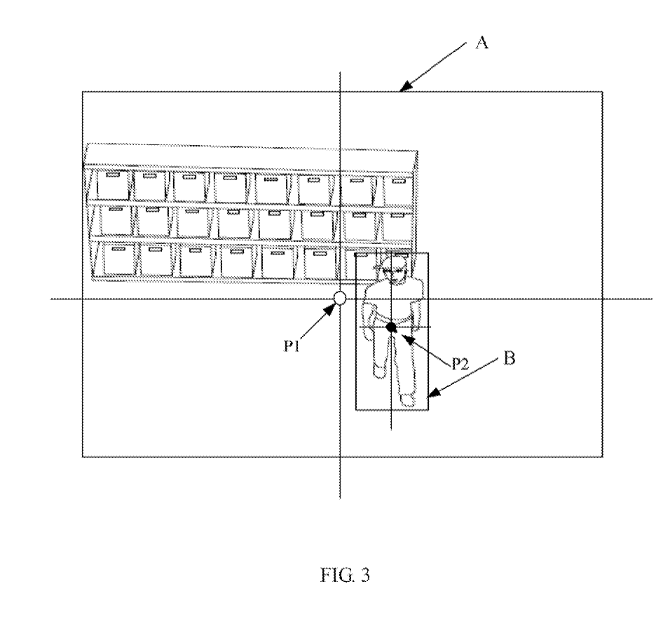

In step S201, the image capture unit 31 captures a scene image of a monitor area, such as an image A shown in FIG. 3.

In step S202, the figure detection module 11 analyzes the scene image using a figure detection method. In the embodiment, the figure detection method may include steps of: pre-storing a large number of characteristics data of human figures to create a figure sample in the storage device 40, and analyzing the scene image by comparing image data of the scene image with the characteristics data of the figure sample that includes head, face, eyes and mouth characteristics, and determining whether a figure image is detected in the scene image according to the comparison.

In step S203, the figure detection module 11 determines whether the scene image includes a figure image according to the analysis. If the scene image includes a figure image, step S204 is implemented. Otherwise, if the scene image does not include a figure image, step S201 is repeated.

In step S204, the figure detection module 11 encloses the figure image within a rectangular area, determines coordinates of a center point of the scene image and coordinates of a center point of the rectangular area, and determines coordinate differences between the center point of the scene image and the center point of the rectangular area. For example, as shown in FIG. 3, the figure image is enclosed within a rectangular area B, P2 represents the center point of the rectangular area B, and P1 represents the center point of the image A. The coordinate differences may be expressed as Dx=P2.x−P1.x, and Dy=P2.y−P1.y.

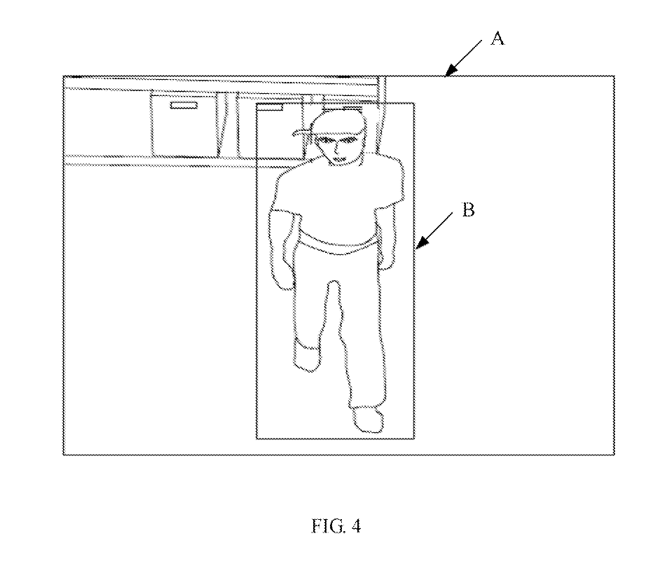

In step S205, the lens adjustment module 12 determines a tilt direction and a tilt angle of the lens 31 to superimpose the center point of the rectangular area on the center point of the scene image based on the coordinate differences. For example, as shown in FIG. 3, the lens adjustment module 12 may determine that the lens 31 needs to be tilted from a current position to a right bottom direction by 30 degrees, to place the center point of the rectangular area B on the center point of the image A (as shown in FIG. 4). When the center point of the rectangular area B is superimposed on the center point of the scene image, the figure image appears at the center of the scene image for a better view of the person appearing in the monitor area.

In step S206, the lens adjustment module 12 determines whether the tilt angle falls within an allowable rotation range of the lens 31. For example, the allowable rotation range of the lens 31 may be 0 degree to 120 degrees, where 120 degrees is the maximum threshold angle that the lens 31 can rotate. If the tilt angle falls within the allowable rotation range of the lens 31, step S207 is implemented, the lens adjustment module 12 generates and sends a first control command to the driving unit 20, so that the driving unit 20 drives the lens 31 to rotate by the tilt angle along the tilt direction, to adjust the center point of the rectangular area so it is superimposed on the center point of the scene image. Then the procedure goes to step S210 from step S207. If the tilt angle falls outside the allowable rotation range of the lens 31 (such as the tilt angle being 122 degrees), step S208 is implemented.

In step S208, the lens adjustment module 12 generates and sends a second control command to the driving unit 20, so that the driving unit 20 drives the lens 31 to rotate by a threshold angle along the tilt direction. For example, if the tilt angle is 122 degrees, and the allowable rotation range of the lens 31 is 0 degree to 120 degrees, then the driving unit 20 drives the lens 31 to rotate 120 degrees according to the second control command. After the second control command is executed, the center point of the rectangular area is still not superimposed on the center point of the scene image, so the lens adjustment module 12 then triggers the UAV flight control module 13 to take action.

In step S209, the UAV flight control module 13 generates and sends a third control command to the driving unit 20, so that the driving unit 20 adjusts a flight orientation and a flight height of the UAV 100 until the center point of the rectangular area is superimposed on the center point of the scene image, so that the figure image appears to be at the center of the scene image (as shown in FIG. 4).

In step S210, the figure detection module 11 determines if a ratio of an area of the rectangular area to a total area of the scene image falls within a preset range. For example, for magnification effect, the preset range may be defined as 15% to 20% for obtaining a clear figure image. If the ratio (such as 16%) falls within the preset range, the procedure ends. Otherwise, if the ratio (such as 10%) falls outside of the preset range, step S211 is implemented.

In step S211, the lens adjustment module 12 determines a focus adjustment range of the lens 31 for adjusting the ratio to fall within the preset range.

In step S212, the lens adjustment module 12 determines if the focus adjustment range falls within a zoom range of the lens 31. For example, the zoom range of the lens 31 may be 24 mm to 85 mm. If the focus adjustment range falls within the zoom range, for example, if the focus adjustment range is 35 mm to 45 mm, step S213 is implemented, and the lens adjustment module 12 generates and sends a fourth control command to the driving unit 20, so that the driving unit 20 adjusts the focus of the lens 31 until the ratio does fall within the preset range. Then, the procedure ends. If the focus adjustment range falls outside the zoom range, for example, if the focus adjustment range is 86 mm to 101 mm, step S214 is implemented.

In step S214, the lens adjustment module 12 generates and sends a fifth control command to the driving unit 20, so that the driving unit 20 adjusts the focus of the lens 31 to a focus threshold value of the zoom range of the lens 31 by executing the fifth control command. For example, as mentioned above, if the zoom range of the lens 31 is 24 mm to 85 mm, whereas the focus adjustment range is 86 mm to 101 mm, then the driving unit 20 adjusts the focus of the lens 31 to be 85 mm. After the fifth control command is executed, if the ratio still does not fall within the preset range, the lens adjustment module 12 triggers the UAV flight control module 13 to further take action, and the procedure goes to step S215.

In step S215, the UAV flight control module 13 generates and sends a sixth control command to the driving unit 20, so that the driving unit 20 adjusts a distance between the UAV 100 and the target person, who appears in the monitor area and corresponds to the figure image, until the ratio falls within the preset range. For example, as shown in FIG. 4, the rectangular area B is at the center of the scene image A, and the ratio of the area of the rectangular area B to the area of the scene image A falls within the preset range of 15% to 20%.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An unmanned aerial vehicle (UAV) control method being executed by a processor of the UAV, the UAV comprising a driving unit and an image capture unit, wherein the image capture unit captures a scene image of a monitored area, the method comprising:
detecting a figure image from the scene image by analyzing the scene image using a figure detection method;
enclosing the figure image within a rectangular area, and determining coordinate differences between a center point of the scene image and a center point of the rectangular area;
determining a tilt direction and a tilt angle of a lens of the image capture unit for superimposing the center point of the rectangular area on the center point of the scene image based on the coordinate differences;
in response to a determination that the tilt angle falls within an allowable rotation range of the lens, generating and sending a first control command to the driving unit, to directly rotate the lens by the tilt angle along the tilt direction; and
in response to a determination that the tilt angle falls outside the allowable rotation range of the lens, generating and sending a second control command to the driving unit, to rotate the lens by a threshold angle of the allowable rotation range along the tilt direction; and
generating and sending a third control command to the driving unit, to adjust a flight orientation and a flight height of the UAV until the center point of the rectangular area is superimposed on the center point of the scene image.

2. The method of claim 1, further comprising:
determining if a ratio of an area of the rectangular area to a total area of the scene image falls within a preset range;
in response to a determination that the ratio falls outside the preset range, determining a focus adjustment range of the lens for adjusting the ratio to fall within the preset range, and determining if the focus adjustment range falls within a zoom range of the lens;
in response to a determination that the focus adjustment range falls within the zoom range of the lens, generating and sending a fourth control command to the driving unit, to directly adjust the focus of the lens until the ratio falls within the preset range;
in response to a determination that the focus adjustment range falls outside the zoom range of the lens, generating and sending a fifth control command to the driving unit, to adjust the focus of the lens to a focus threshold value of the zoom range of the lens; and
generating and sending a sixth control command to the driving unit, to adjust a distance between the UAV and a person who appears in the monitor area and corresponds to the figure image, until the ratio falls within the preset range.

3. The method of claim 1, wherein the figure detection method comprises:
pre-storing a number of characteristics data of human figures to create a figure sample in a storage device of the UAV;
comparing image data of the scene image with the characteristics data of the figure sample; and
determining whether the figure image is detected in the scene image according to the comparison.

4. The method of claim 1, wherein the image capture unit is a video camera having night viewing capability and pan/tilt/zoom functions.

5. The method of claim 4, wherein the driving unit comprises one or more motors that drives the lens to rotate within the allowable rotation range and adjust the focus of the lens within the zoom range, and adjust a flight height and a flight orientation of the UAV.

6. An unmanned aerial vehicle (UAV) comprising:
a storage device;
at least one processor;
a driving unit;
an image capture unit that captures a scene image of a monitored area; and
one or more programs stored in a storage device comprising one or more programs and the one or more programs executable by the at least one processor, the one or more programs comprising:
a figure detection module operable to detect a figure image from the scene image by analyzing the scene image using a figure detection method, enclose the figure image within a rectangular area, and determine coordinate differences between a center point of the scene image and a center point of the rectangular area;
a lens adjustment module operable to determine a tilt direction and a tilt angle of a lens of the image capture unit for superimposing the center point of the rectangular area on the center point of the scene image based on the coordinate differences, and in response to a determination that the tilt angle falls within an allowable rotation range of the lens, further operable to generate and send a first control command to the driving unit, to directly rotate the lens by the tilt angle along the tilt direction; and
a UAV flight control module operable to generate and send a second control command to the driving unit, to rotate the lens by a threshold angle of the allowable rotation range along the tilt direction in response to a determination that the tilt angle falls outside the allowable rotation range of the lens, and further operable to generate and send a third control command to the driving unit, to adjust a flight orientation and a flight height of the UAV until the center point of the rectangular area is superimposed on the center point of the scene image.

7. The UAV of claim 6, wherein:
the figure detection module is further operable to determine if a ratio of an area of the rectangular area to a total area of the scene image falls within a preset range;
the lens adjustment module is further operable to determine a focus adjustment range of the lens for adjusting the ratio to fall within the preset range, and determine if the focus adjustment range falls within a zoom range of the lens in response to a determination that the ratio falls outside the preset range, and generate and send a fourth control command to the driving unit to directly adjust the focus of the lens until the ratio falls within the preset range; and
the UAV flight control module is further operable to generate and send a fifth control command to the driving unit in response to a determination that the focus adjustment range falls outside the zoom range of the lens, to adjust the focus of the lens to a focus threshold value of the zoom range of the lens, and generate and send a sixth control command to the driving unit, to adjust a distance between the UAV and a person, who appears in the monitor area and correspond to the figure image, until the ratio falls within the preset range.

8. The UAV of claim 6, wherein the figure detection method comprises:
pre-storing a number of characteristics data of people to create a figure sample in a storage device of the UAV;
comparing image data of the scene image with the characteristics data of the figure sample; and
determining whether the figure image is detected in the scene image according to the comparison.

9. The UAV of claim 6, wherein the image capture unit is a video camera having night viewing capability and pan/tilt/zoom functions.

10. The UAV of claim 9, wherein the driving unit comprises one or more motors that drives the lens to rotate within the allowable rotation range and adjust the focus of the lens within the zoom range, and adjust a flight height, a flight orientation, and a flight speed of the UAV.

11. A non-transitory computer-readable medium storing a set of instructions, the set of instructions capable of being executed by a processor of an unmanned aerial vehicle (UAV) to perform a UAV control method, the UAV comprising a driving unit and an image capture unit, wherein the image capture unit captures a scene image of a monitored area, the method comprising:
detecting a figure image from the scene image by analyzing the scene image using a figure detection method;
enclosing the figure image within a rectangular area, and determining coordinate differences between a center point of the scene image and a center point of the rectangular area;
determining a tilt direction and a tilt angle of a lens of the image capture unit for superimposing the center point of the rectangular area on the center point of the scene image based on the coordinate differences;
in response to a determination that the tilt angle falls within an allowable rotation range of the lens, generating and sending a first control command to the driving unit, to directly rotate the lens by the tilt angle along the tilt direction; and
in response to a determination that the tilt angle falls outside the allowable rotation range of the lens, generating and sending a second control command to the driving unit, to rotate the lens by a threshold angle of the allowable rotation range along the tilt direction; and
generating and sending a third control command to the driving unit, to adjust a flight orientation and a flight height of the UAV until the center point of the rectangular area superposes the center point of the scene image.

12. The medium of claim 11, wherein the method further comprises:
determining if a ratio of an area of the rectangular area to a total area of the scene image falls within a preset range;
in response to a determination that the ratio falls outside the preset range, determining a focus adjustment range of the lens for adjusting the ratio to fall within the preset range, and determining if the focus adjustment range falls within a zoom range of the lens;
in response to a determination that the focus adjustment range falls within the zoom range of the lens, generating and sending a fourth control command to the driving unit, to directly adjust the focus of the lens until the ratio falls within the preset range;
in response to a determination that the focus adjustment range falls outside the zoom range of the lens, generating and sending a fifth control command to the driving unit, to adjust the focus of the lens to a focus threshold value of the zoom range of the lens; and
generating and sending a sixth control command to the driving unit, to adjust a distance between the UAV and a person, which appears in the monitor area and corresponds to the figure image, until the ratio falls within the preset range.

13. The medium of claim 11, wherein the figure detection method comprises:
pre-storing a number of characteristics data of human figures to create a figure sample in the medium;
comparing image data of the scene image with the characteristics data of the figure sample; and
determining whether the figure image is detected in the scene image according to the comparison.

14. The medium of claim 11, wherein the image capture unit is a video camera having night viewing capability and pan/tilt/zoom functions.

15. The medium of claim 14, wherein the driving unit comprises one or more motors that drives the lens to rotate within the allowable rotation range and adjust the focus of the lens within the zoom range, and adjust a flight height and a flight orientation of the UAV.
